(19) United States
(12) Patent Application Publication
(10) Pub. No.: US 2013/0171596 A1
(43) Pub. Date: Jul. 4, 2013

(54) AUGMENTED REALITY NEUROLOGICAL EVALUATION METHOD

(71) Applicant: Barry J. French, Bay Village, OH (US)

(72) Inventor: Barry J. French, Bay Village, OH (US)

(73) Assignee: Barry J. French, Bay Village, OH (US)

(21) Appl. No.: 13/732,703

(22) Filed: Jan. 2, 2013

Related U.S. Application Data
(60) Provisional application No. 61/582,924, filed on Jan. 4, 2012.
(60) Provisional application No. 61/635,318, filed on Apr. 19, 2012.
(60) Provisional application No. 61/725,188, filed on Nov. 12, 2012.

(51) Int. Cl. G09B 19/00

(52) U.S. Cl. CPC G09B 19/00
USPC 434/236

(57) ABSTRACT

A system and method for neurological testing involves prompting a subject or user to engage in body and head movements, measuring physical response, and then using the measured response to evaluate the neurological condition of the subject. The subject may wear a head-mounted display, for example, to aid in prompting the head and/or body movements. The subject may be prompted to engage in movements simulating a real-world task, such as a sports-specific activity. Results may be compared with those of a baseline test. The evaluation may be used to aid in determining if the user or subject can return to the task, for example to return to activity in a sport during which the user sustained a possible neurological injury.

This application claims priority under 35 USC 119 to U.S. Provisional Application No. 61/582,924, filed Jan. 4, 2012, to U.S. Provisional Application No. 61/635,318, filed Apr. 19, 2012, and to U.S. Provisional Application No. 61/725,188, filed Nov. 12, 2012, all of which are incorporated by reference in their entireties.

This application is related to U.S. Patent Publication 2011/0270135 A1, published Nov. 3, 2011, published off of U.S. application Ser. No. 12/927,943, filed Nov. 30, 2010, which is incorporated by reference in its entirety.

### FIELD OF THE INVENTION

The invention is in the field of neurological evaluation systems and methods.

### DESCRIPTION OF THE RELATED ART

The paper titled “Cleveland Clinic Concussion (C3) App Overview”, written by Jay L. Alberts, Ph.D., which is incorporated herein by reference, states that “Concussions or mild traumatic brain injury (mTBI) result in a multitude of cognitive and motor impairments, unique to each athlete, soldier or patient. While multiple software systems exist to assess cognitive function (ImPact, CogSport, ANS Vital Signs), a reliable, objective, and portable testing platform to comprehensively assess cognitive and motor function, including postural stability and dynamic visual acuity, does not exist.”

The Alberts paper also notes several attributes of the assessment device described within: “The advantages of using a mobile device over the NeuroCom system in the assessment of balance in concussion include: decreased cost (˜$500 vs. $100,000); increased portability, pervasiveness, minimal space requirements and automatic data processing and output. Instrumentation of the athlete during BESS testing addresses a fundamental gap in the assessment of concussion.”

The paper also notes that “Dynamic visual acuity has been shown to be an excellent predictor of recovery from concussion.” (Gottshall K D A, Gray N, McDonald E, Hoffer M E. Objective vestibular tests as outcome measures in head injury patients. Laryngoscope. 2003; 113:1746-1750)

In summary, the aforementioned paper describes a low cost portable device that provides a “cognitive-motor function test, postural stability and visual-vestibular system function (static and dynamic visual acuity) assessment.”

The need exists for a portable, affordable, easy-to-use device that provides objective measurements of an athlete's capacities to assist with return to play decisions post a concussion. It is desirable that any such device be conveniently usable in the vicinity of the athletic field or court in the event of an injury during competitive game play.

Currently employed neurocognitive tests for concussion recovery assessment measure the speed and accuracy of tests of attention, speed, learning and working memory while the athlete is sedentary. Accordingly, such tests measure isolated capacities, not global athletic capabilities which may be more relevant to the athlete's fitness to return to game play.

Research papers that include “Assessment and restoration of movement skills should address all three systems—musculoskeletal, sensory & cognitive, not only muscular.” (Singer, Vlayen, et al.), “Combining exercise with virtual reality has the advantage of increasing stimulation and interaction and, since it makes the exercise session more engaging, it provides a useful tool to integrate cognitive and physical tasks . . . the opportunities it (virtual reality) affords for both re-learning and assessment are immense.” (Greatly, Improving Cognitive Function After Brain Injury: The Use of Exercise and Virtual Reality) provide further support for measuring not just isolated capacities, but global athletic performance capabilities as well.

The study “Reliability of a Graded Exercise Test for Assessing Recovery From Concussion” reported that “The requirement that the concussed athlete who is asymptomatic at rest exercise to maximum without exacerbation of symptoms before RTP (Return-to-Play) recognizes the physiologic basis of concussion, which is supported by evidence of cerebral and whole-body physiological dysfunction after concussion. Provocative exercise testing provides the opportunity to determine the physiologic parameters of symptom exacerbation such as heart rate (HR) and blood pressure. This would allow the clinician not only to identify the athlete who is not ready to RTP but also to determine the level and extent of recovery of the concussed athlete.”

This study concluded that the “Balke exercise treadmill test has very good IRR and sufficient maximum HR (heart rate) RTR (return to play) for identifying patients with symptom exacerbation due to concussion. Symptom reports alone are nonspecific and highly variable, and NP test performance at rest improves in most patients, even in those with ongoing symptoms. The symptom exacerbation threshold during the exercise test in our opinion adds an important and more objective element to help clinicians make the RTP decision in athletes.”

### SUMMARY OF THE INVENTION

According to as aspect of the invention, a method of neurological evaluation a person includes the steps of: providing the person with a wearable display and at least one body movement sensor; prompting physical movement of the person, including prompting physical movement of a head of the person; during the prompting physical movement, updating a view in the wearable display, based on movement of the head of the person; measuring movement of the person by tracking physical location of the at least one body movement sensor; and evaluating a neurological condition of the person, based at least in part on measured movement of the at least one body movement sensor.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

The annexed drawings, which are not necessarily to scale, show various aspects of the invention.

FIG. 1 is a schematic view of a system or device usable for accomplishing a method of the present invention.

FIG. 2 is a block diagram of the electronics pack of the system or device of FIG. 1.

FIG. 3 depicts an alternative embodiment of system or device usable for accomplishing a method of the present invention.

FIG. 4 is a block diagram of the electronics pack of the system or device of FIG. 3.

FIG. 5 is a flow chart of operation of the system of FIG. 1.

FIG. 6 is a flow chart of operation of the system of FIG. 3.

FIG. 7 depicts an optical overlay-based augmented reality system, in accordance with a possible use of the systems of FIGS. 1 and 3.

FIG. 8 is a flowchart illustrating operation of the base station computer of FIG.

FIG. 9 is a high-level flowchart illustrating a method of the present invention.

### DETAILED DESCRIPTION

A system and method for neurological testing involves prompting a subject or user to engage in body and head movements, measuring physical response, and then using the measured response to evaluate the neurological condition of the subject. The subject may wear a head-mounted display, for example, to aid in prompting the head and/or body movements. The subject may be prompted to engage in movements simulating a real-world task, such as a sports-specific activity. Results may be compared with those of a baseline test. The evaluation may be used to aid in determining if the user or subject can return to the task, for example to return to activity in a sport during which the user sustained a possible neurological injury.

For the purposes of this application, references below to the “AR Device” or an “augmented reality system” refer to a system or systems disclosed in U.S. Patent Publication 2011/0270135, which is incorporated by reference in its entirety. The descriptor “athlete” used in this provisional application should not be construed as to limit the applications of this AR Device, which is equally applicable to populations that include, but are not limited to, soldiers, those returning to physically demanding work environments, as well as the general population.

Three components may constitute an augmented reality system: User motion tracking means or sensors, a wearable display such as a head-mounted display (HMD) and body-worn computing power/capability. Feng Zhou et all identified some of the challenges of implementing AR, “(a) graphics rendering hardware and software that can create the virtual content for overlaying the real world, (b) Tracking techniques so that changes in the viewer's position can be properly reflected in the rendered graphics, (c) Tracker calibration and registration tools for precisely aligning the real and virtual views when the user view is fixed, and (d) Display hardware for merging virtual images with views of the real world.” With AR the graphic overlay is continually refreshed to reflect the movement of the athlete's head.

There are a number of suitable means that AR devices employ to track the user's moment-to-moment position. Sensing means or sensors may include a digital compass, 3-axis orientation and 3-axis accelerometers as well as differential GPS for certain outdoor applications. Additionally, passive magnetic field detection sensors can be combined with these aforementioned sensors. This use of multiple sensors generates the data to both measure and refine the user's physical performance and kinematics. For certain implementation, sensors providing only positional information, or sensors only providing orientation specific data may suffice predicated on the application.

One embodiment for tracking the user's movement is taught in US patent application US 2010/0009752 by Amir Rubin. It describes the use of multiple body-worn magnetic sensors each capable of calculating the absolute position and orientation. As taught, these sensors can be attached on a limb, the body core, or the user's head. The sensors communicate wirelessly with a “base station” through an active sensor, but the sensors can also be connected with cables to the active sensor, or all of the sensors could communicate directly with the base station wirelessly. This sensor system enables essentially the real-time tracking of the position and orientation of various points of interest on the athlete's body. Such points of interest may include one or both knees, ankles, arms, the body core and/or the user's head region. This tracking provides sufficient update rates and accuracy to effectively measure the parameters of interest. It is immune from interference from ambient light, so it can be used outdoors. And being wireless, it does not restrict the user's movement.

Head-mounted displays (HMDs) enable the user to view graphics and text produced by the augmented reality system. Examples of suitable HMDs include: optical see-through HMDs and video see-through HMDs. For the type of dynamic movement contemplated in using AR devices, “optical see-through” models have certain performance benefits. Optical see-through HMDs enable the user to see the real world in addition to the graphic overlay with his natural eyes, which is preferred for sport-specific applications of AR devices, where the user may occasionally move at high speed. This graphic overlay may be accomplished by positing a small display device devices in the field of vision of one or both eyes of the user. The HMD superimposes digital information (e.g., images and/or alphanumeric information) upon the athlete's view of the training space, thereby enabling the continuous delivery of digital information regardless of the viewpoint of the athlete. With computer graphics being overlaid on the natural (real) world view, these HMD have low time delays, the athlete's view of the natural world is not degraded.

An example of an optical see-through wearable display is the Microvision Color Eyewear. It is characterized as a “retinal display”. Microvision's eyewear “combine(s) the tiny, thin PicoP full color laser projection module with . . . clear optics that channel the laser light and direct it to the viewer's eye—all without sacrificing an unobstructed view of the surroundings.” This model does not incorporate sensing means, and Microvision's retinal display is not currently in commercial production. Other examples of HMDs are Vuzix M100 Smart Glasses, and products developed under Google's Project Glass research and development program.

Video see-through HMDs use cameras mounted near the user's head/eye region to take video images of the real world and feed them back to a computing system. The computing system can then take the captured images of the real world and overlay or embed the virtual objects into each frame of video to form a composite image. This new sequence of images or video is then projected back to the HMD for viewing by the user. A known deficit with video see-through HMDs is the time lag associated with capturing, processing and displaying the augmented images; all of which can cause the user to experience a delay in viewing the images. As technology improves, this delay will be become less noticeable. An example of a video see-through eyewear is the Vuzix WRAP 920AR, an HMD that incorporates motion tracking.

Still another approach to enabling the user to see a view of the natural world combined with computer-generated graphics can be achieved by mounting a micro LCD display inside a pair of glasses, or using a micro projector to project an image onto a small screen or glasses worn by the user.

The HMD or wearable display, regardless of the type, may incorporate sensing means to determine the orientation and direction/position of the user's head (eyes). Alternatively, the AR device may incorporate a discrete sensor to track where the user's head is positioned and oriented. This is needed so the correct view of the simulation can be displayed to the user to correspond to what they are looking at in the natural world.

Without proper registration of the digital information, the ability of the system to measure the physical performance or kinematics of the user, or for the static and dynamic objects to realistically interact with the user may be dampened. Distinguishable objects (“markers”) placed in the physical space may play an important role to AR's performance. U.S. Patent Publication 2004/0080548, the figures and description of which are incorporated by reference, describes the use “of a plurality of at least three tracking fiducials selectively each respectively located in fixed predetermined locations in the observation space . . . .” It is advantageous, but not necessary, to employ proper means to register and precisely align the real and virtual views is advantageous.

Examples of suitable computing devices for the body-worn computing power/capability include cellular phones and audio playback devices, or the base station can be a dedicated unit designed specifically for the AR device. The portability of the computing device is an important factor, as the user will be performing vigorous exercise while receiving biofeedback. In addition, at least some of such devices have on-board accelerometers and/or position sensors (e.g., GPS sensors), allowing the computer device to also function as a sensor.

The various sensors may communicate with the computing device, which preferred embodiment is worn/carried on the user's body. One embodiment employs an Apple iPod, iTouch, iPhone, iPad, and/or other portable computer and/or communication device. Alternatively, the various body-worn sensors may communicate with a computing device not attached to the user. For example, the sensors may wirelessly communicate with a computing device that is not worn by the user or subject. The computing device may also upload user data and information to send and/or receive data and information to a personal computer and/or to a remote system preferably via a network connection, such as over the Internet, which may be maintained and operated by the user or by another third party.

Data can be transferred to a processing system and/or a feedback device (audio, visual, etc.) to enable data input, storage, analysis, and or feedback on a suitable body-worn or remotely located electronic device. Software written for the body worn computing device facilitates communication with the sensors employed. Where a commercially available sensor system is employed, software is written for the computing device that takes the positional coordinates of such sensors, as well as potentially the orientation of each sensor, and generates the displayed graphics.

Since the current commercial HMD devices use a standard VGA or other video input connection (e.g. s-video), a standard video card in the computing device would output a suitable signal to generate the display. When a micro LCD is used for the HMD, additional circuitry may be needed to power and convert the data from the computing device's video output for display on the HMD. This may be true for other HMDs as well, that do not use standard video connections and protocols.

Software may also be developed to synchronize the data from the computing device to another computer and/or the internet to facilitate sharing of information or further analysis. Data may then be saved and used for comparisons to certain metrics, or compared to other users' information.

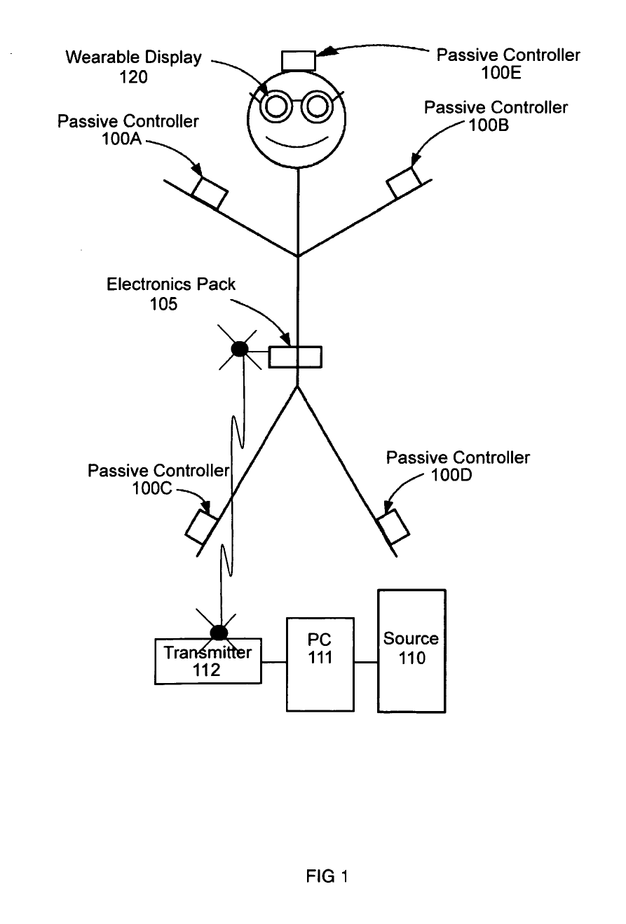

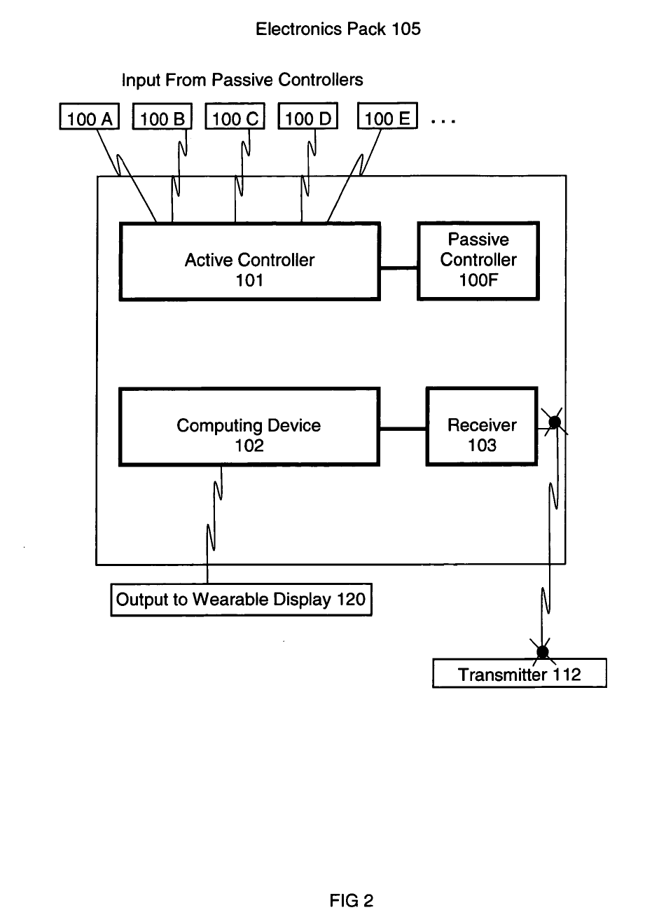

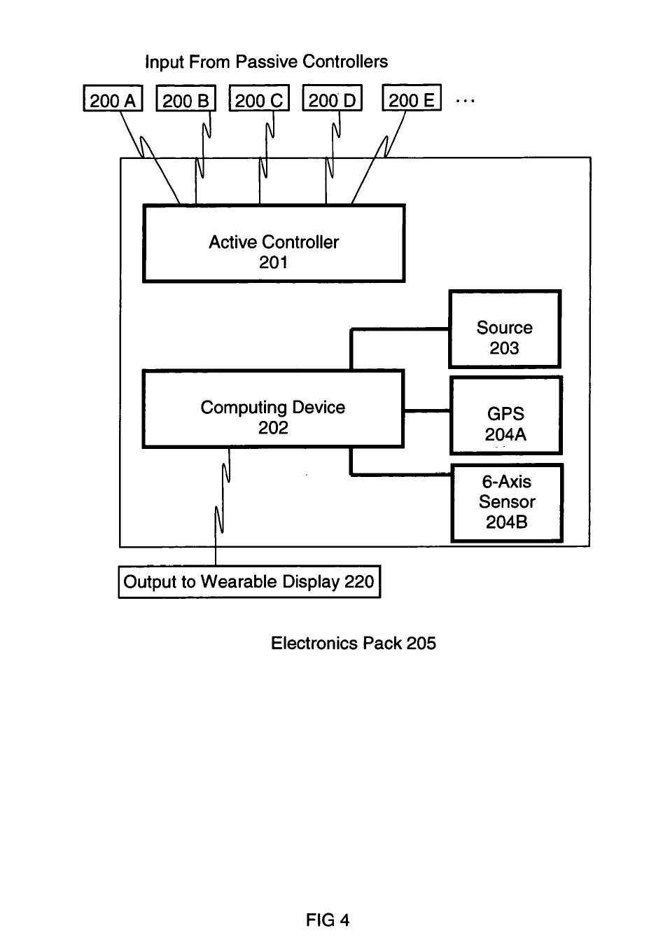

FIGS. 1-8 depict certain aspects and features of certain embodiments of AR devices. Referring to FIGS. 1, 2 and 5, a source 110 generates a magnetic field that is detected by the passive controllers 100A-F secured to the arms, legs and head of a user as illustrated via the stickman. The passive controllers 100A-F communicate with an active controller 101 via wired or wireless transmission. The active controller 101 then communicates the position and orientation of all of the passive controllers 100A-F back to the source 110 via wireless transmission. A personal computer 111 then reads the data at the source 110 and re-transmits the data through transmitter 112 to receiver 103 wirelessly (e.g. Bluetooth, RF, etc). A body worn computing device 102 (e.g., a personal computer, smart phone, iPod, or other computing system) processes the received data and integrates the data into a running simulation. The computing device 102 is coupled via cable, or other means (preferably wireless) to a wearable display 120 for display output of the simulation in operation that includes continuously providing realtime visual physical performance information to the user while the user is moving to enable the user to detect physical performance constructs that expose the user to increased risk of injury or that reduce the user's physical performance.

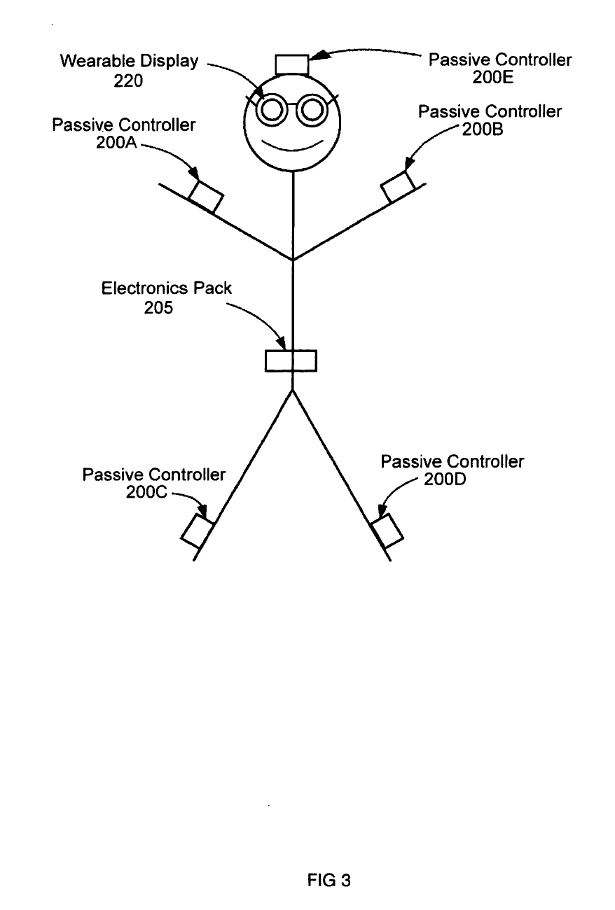

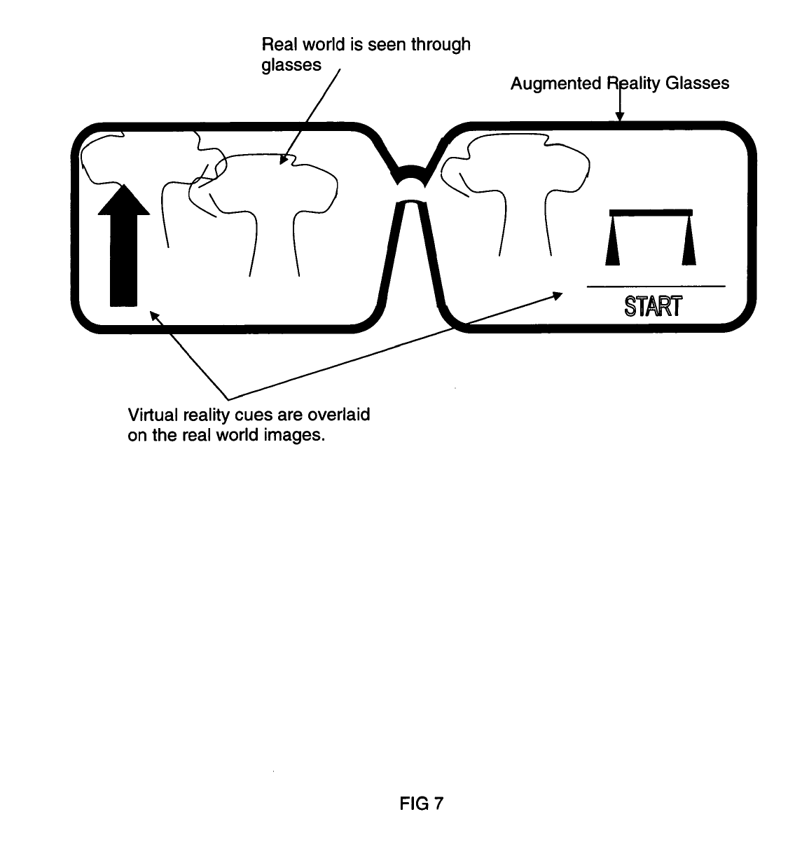

Referring now to FIGS. 3, 4, and 6, an alternative embodiment is depicted that includes a source 203 that is body worn and generates a magnetic field which is detected by the passive controllers 200A-E. The passive controllers 200A-E communicate with an active controller 201 can via wired or wireless transmission. The active controller 201 then communicates the position and orientation of all of the passive controllers 200A-E back to the source 203 via wireless transmission. A body worn computing device 202 (e.g., a personal computer, smart phone, iPod, or other computing system) is connected to the source 203 and communicates with the source 202 via wired or wireless transmission (e.g. Bluetooth, RF, etc.). The computing device 202 is also coupled to a GPS receiver 204A or other means for determining the exact position in free space (e.g. RFID Tags, Indoor GPS, etc) and also a 6-axis sensor 204B, which contains a 3-axis accelerometer and a 3-axis gyroscope. The computing device 202 processes the received data from all three sources 203, 204A and 204B and integrates the data into the running simulation. The computing device 202 is coupled via cable, or other means to a wearable display 220 for display output of the simulation in operation that includes continuously providing realtime visual physical performance information to the user while the user is moving to enable the user to detect physical performance constructs that expose the user to increased risk of injury or that reduce the user's physical performance. Referring to FIG. 7, the wearable display 220 depicts real world images seen through the glasses 220 that include three trees, and virtual reality cues overlaid on the real world images. The virtual reality depicts a start and a racing hurdle on the right glass and an arrow on the left glass. The arrow tells the user that she must jump higher to clear the hurdle. Although the right and left glasses show different images, the user sees the three trees, hurdle and arrow as a single display.

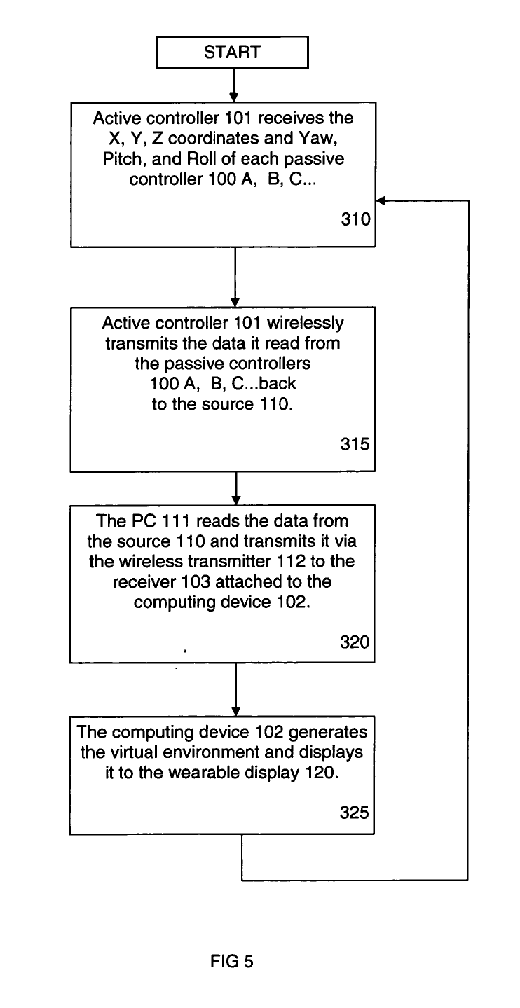

FIG. 5 shows a flowchart of use of an AR device. In step 310, the active controller 101 reads the X, Y, and Z locations and the Yaw, Pitch, and Roll of each passive controller 100A-F. Each of the passive controllers 100A-F is connected to the active controller 101 by wires or by a wireless communication means such as Bluetooth or RF. A suitable wireless communication device is the MotionStar Wireless LITE from Ascension Technologies. Up to 13 individual sensors can be connected to the active controller 101, which can monitor three dimensional positions and orientations of each passive controller 100A-F using a magnetic field generated from the source 110. All measurements of position and orientation are relative to the location of the source unit 110. In step 315, the active controller 101 transmits the three dimensional position and orientation of each passive controller 100A-F to the source 110 via its built in wireless transmitter.

In step 320, the personal computer 111 reads the three dimensional information from the source 110 and uses transmitter 112 to transmit the information wirelessly to receiver 103. This step is necessary because the active controller 101 transmits the data directly to the source unit 110. If the transmission protocol were known and was able to be mimicked by the body worn computing device 102, this step would not be needed, as the computing device 102 could simply communicate with the active controller 101 directly. In step 325, the computing device 102 generates the virtual simulation using the positional and orientation data from the passive controllers 100A-F and displays the information on the wearable display 120. The wearable display 120 is preferably an optical see-through HMD from Microvision, but at the current time no model is available to the public. Alternatively, a video see-through HMD from Vuzix (e.g. WRAP 920AR+) is the preferred type of HMD. Since the display obscures the user's vision, the 920AR+ contains two video cameras that record user's natural world (their viewpoint). Since this type of wearable display cannot overlay the simulation directly onto the screen, there is an additional step the computing device needs to perform. The computing device 102 needs to take the video obtained from the integrated video cameras in the wearable display 120 and combine those images with the simulation currently in progress. This combined picture of the real (natural) world plus the simulation (virtual) world can then be displayed to the user on the wearable display 120. At such time as a suitable optical see-through display is commercially available, this step will not be necessary. In an optical see-through display the wearable display is transparent and the simulation can be projected directly onto the screen and the user can see the natural world behind the display.

Some wearable displays include sensors to calculate the position and orientation of the user's head, but if not, a passive controller 100E may be attached to the user's head to determine the exact position and orientation. This extra sensor allows the computing device 102 to know exactly what the user is looking at in the real and virtual worlds, so the correct camera angle of the virtual world can be displayed to correlate with the real world image the user is seeing. Without this sensor 100E, if the user turned her head to the left, the image would not change and the augmented reality simulation would not work. The sensors in a wearable display and/or in a body-mounted computer may be used to track overall body position of the subject.

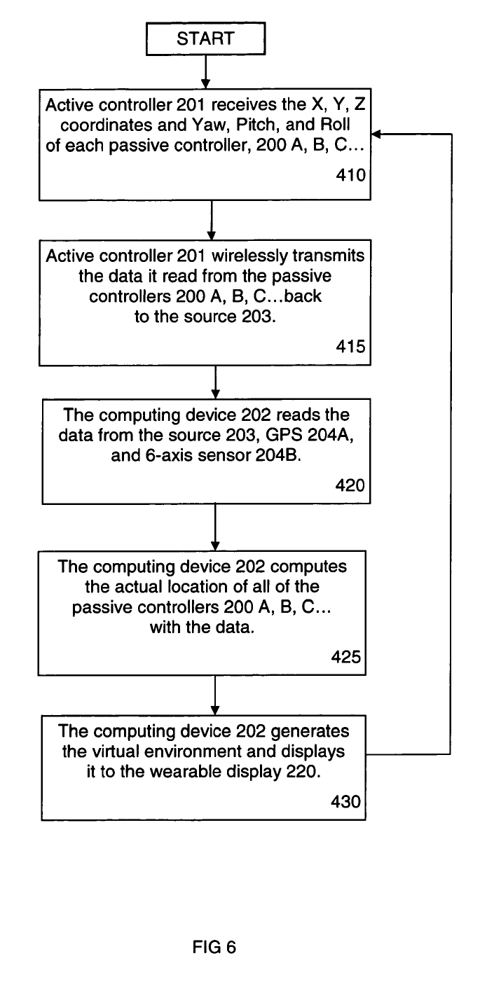

Referring now to FIG. 6, a flowchart of an alternative embodiment AR device can be seen. In step 410, the active controller 201 reads the X, Y, and Z locations and the Yaw, Pitch, and Roll of each passive controller 200A-E. Each of the passive controllers 200A-E is connected to the active controller 201 by wires or by a wireless communication means such as Bluetooth or RF. A suitable device as described is the MotionStar Wireless LITE from Ascension Technologies. Up to 13 individual sensors can be connected to the active controller 201, which can monitor three dimensional positions and orientations of each sensor 200A-E using a magnetic field generated from the source 203. All measurements of position and orientation are relative to the location of the source unit 203. In step 415, the active controller 201 transmits the three dimensional position and orientation of each passive controller 200A-E to the source 203 via its built in wireless transmitter.

In step 420, the body worn computing device 202 reads the three dimensional information from the source 203 and the global positional data from the GPS receiver 204A. A suitable USB GPS receiver 204A is connected to the computing device 202 via wired or other wireless transmission means. A highly accurate GPS receiver 204A is preferred as it will improve the appearance of the simulation and the accuracy of the performance data. In this embodiment the GPS receiver 204A is used to supplement the information from the passive controllers 200A-E. Since the source is now body-worn, the positional and orientation data received from the passive controllers 200A-E is now relative to the location of the source device 203. Since the GPS sensor 204A only contains the X, Y, Z positional data of itself, a means of tracking the orientation of the sensor 204A location is also needed. This is supplemented by a 6-axis sensor 204B, which can be integrated into the computing device 202 in certain instances (e.g. iPhone, iPod Touch, etc). The 6-axis sensor integrates a 3-axis accelerometer and 3-axis gyroscope. Using the integrated gyroscope, the computing device 202 now knows the exact orientation of the sensor 204B. This sensor 204B, along with the GPS sensor 204A and source 203, may be attached at the base of the spine or at other suitable positions on the body. The spine is representative of a location on the body that maintains a relatively fixed position regardless of the actions of the upper and lower body. The GPS receiver has reported accuracy to approximately 2 cm, but the frequency of GPS updates is quite small, and therefore cannot be used for a millisecond resolution position sensor. Accordingly, the GPS signal is used to correct the drift encountered when tracking a point in space by a 6-axis sensor. Since drift from the 6-axis sensor degrades over long time periods, the GPS sensor's updated position can be used to address the drift issue once a new position is known.

In some circumstances (e.g. indoors) the GPS sensor will not be able to determine the exact location of the user because the receiver cannot detect signals inside buildings. There are other positioning systems for use indoors that have accuracies in the range from an inch to a centimeter that would serve as a replacement. Indoor GPS systems as well as RFID locator systems are capable of calculating the exact position of an object indoors down to accuracies similar to those of a GPS system. The GPS sensor may be replaced by one such sensor system to facilitate the use of the AR device indoors. In step 425, since the computing device 202 knows the exact orientation of the user, as well as the location of the source 203 relative to all of the passive controllers 200A-E, the computing device 202 can calculate the exact position of every passive controller 200A-E. This allows the computer 202 to place the user in the simulation properly and track the location of all sensors 200A-E over large distances. Drift encountered by the 6-axis sensor over time can be calculated out and corrected every time a new reading from the GPS signal is received. This gives the computing device 202 a millisecond resolution position and orientation of the user's current position.

In step 430 the computing device 202 generates the virtual simulation using the positional and orientation data from the sensors 200A-E and displays the information on the wearable display 220. The wearable display is preferably an optical see-through HMD from Microvision, but at the current time no model is available to the public. Instead, a video see-through HMD from Vuzix (e.g. WRAP 920AR+) is employed. Since the display obscures the user's vision, the 920AR+ contains two video cameras that record the user's natural world (his/her viewpoint). Since the wearable display 220 cannot overlay the simulation directly onto the screen, there is an extra step the computing device 202 needs to perform. The computing device 202 needs to take the video obtained from the integrated video cameras in the wearable display and combine those images with the simulation currently in progress. This combined picture of the real (natural) world plus the simulation (virtual) world can then be displayed to the user on the wearable display. This step would not be necessary with optical see-through displays. In an optical see-through display the wearable display is transparent and the simulation can be projected directly onto the screen and the user can see the natural world behind the display.

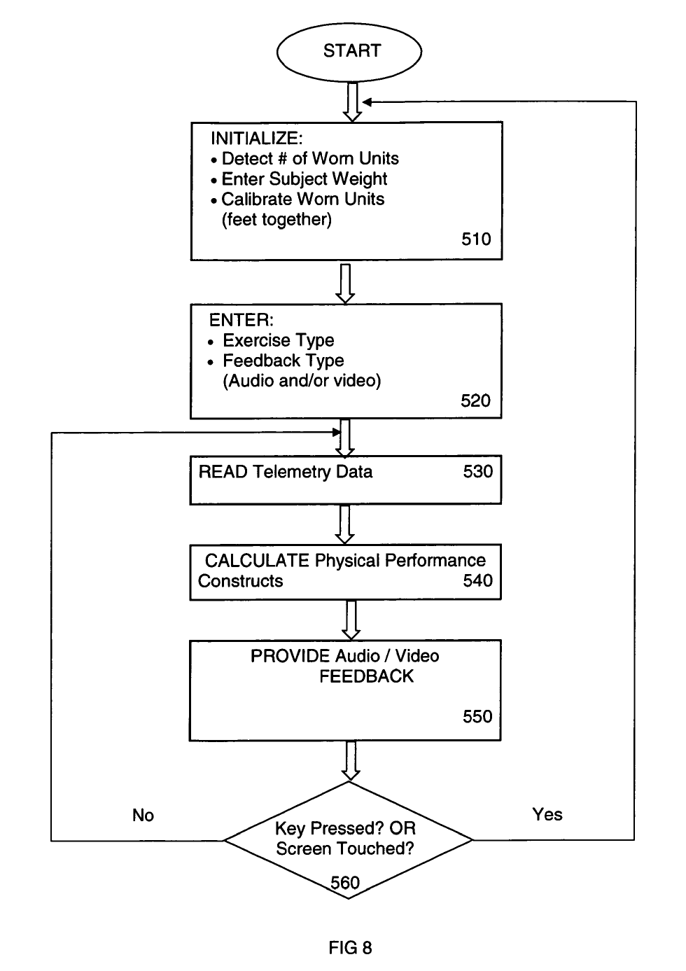

Some wearable displays include sensors to calculate the position and orientation of the user's head, but if not, a passive controller 200E may be attached to the user's head to determine the exact position and orientation. This extra sensor enables the computing device to know exactly what the user is looking at in the real and virtual worlds so the correct camera angle of the virtual world can be displayed to correlate with the real world image the user is seeing. Without this sensor 200E, if the user turned her head to the left, the image would not change and the augmented reality simulation would not work. Referring now to FIG. 8, a flowchart of the computing device of FIG. 1 is depicted. Referring to block 510, the computing device 102 determines the number of body worn passive controllers 100A-F that are within the vicinity of the source 110 (block 510). The computing device 102 then prompts the user to enter his weight, followed by a sensor calibration step where the user is instructed to stand upright with feet held together (block 510). After the completion of the initialization (block 510), the computing device 102 enters into the operation mode, which starts with the selection of the exercise type and the preferred mode of feedback, such as audio in the form of synthesized speech and/or video in the form of bar graphs for chosen parameters (block 520). The computing device 102 then reads the data provided by the passive controllers 100A-F (block 530), calculates predetermined physical performance constructs (block 540), and provides realtime visual (or audio) feedback to the user via the wearable display 120 (block 550). Referring now to block 560, If the user presses a key or touches a screen, the computing device 102 then returns to block 510 and the system is reinitialized, otherwise, the computing device 102 returns to block 530 where the computing device 102 again reads the data provided by the passive controllers 100A-F to ultimately provide new physical performance constructs to the user for continuously monitoring his or her motion and for continuously providing realtime visual physical performance information to the user while the user is moving to enable the user to detect physical performance constructs that expose the user to increased risk of injury or that reduce the user's physical performance.

The AR Device employs techniques of augmented reality, simulation and exercise science to “immerse” the athlete in a simulated environment that replicates the spontaneous, rapidly-changing nature of sports competition by eliciting reaction-based, 3-dimensional movement responses. Interactive protocols challenge the athlete's perceptual-cognitive-kinesthetic linkage to enable the measurement of movement performance and physiological response that serve as the foundation for a novel global performance assessment tool to assist in return-to-play decisions post concussion. Alternatively, it could be rephrased that the AR Device assesses global athletic performance by challenging the athlete's sensory, cognitive, and neuromuscular systems. The AR Device contributes previously unavailable objective data to assist in return-to-play decisions by evaluating an athlete's physical and physiologoical performance in a simulation of the dynamic environment of actual competition to which the athlete will return.

The AR Device uniquely assesses factors relating to the athlete's physiological and/or physical performance during locomotion by providing visual stimuli (cuing) and continuous feedback regardless of the direction in which the athlete is moving or the direction at which the athlete is gazing (looking). The AR Device uniquely enables the assessment of attention, reaction time, processing speed and movement capabilities in a simulation of the athlete's competitive environment, i.e. reacting to dynamic exercise stimuli. It is well accepted that movement defines functional capability. Orthopedic injuries affect the ability to react and move, as do brain injuries that impede the neurological system from properly signaling the muscularskeletal system. Measurement of the fundamental components of movement allows the clinician, trainer or coach to view disability and capability as a continuum of the capacity for movement.

This contrasts with neuro-physical testing performed on balance testing devices that are limited to assessing aspects of the athlete's visual, vestibular or somatosensory systems that the athlete may rely on to maintain balance. The athlete typically remains stationary, i.e. their feet remain essentially in a fixed position. The perceived deficits of known concussion assessment devices include: 1) their inability to elevate the athlete's metabolic rate, as measured by heart rate, to levels consistent with game play, 2) they do not measure the athlete's reaction time to spontaneous (unplanned) stimuli that act to elicit sport-relevant movement responses, which are defined as multi-vector (3-dimensional) movement responses comprising distances approximating those of game play, and 3) they do not challenge the athlete's vision and vestibular system in a sport-relevant manner. They do elicit from the athlete 360 degree movements, i.e. the lateral, linear and rotational (turning) movements inherent in most sports.

With the AR Device, testing is not limited to isolated capacities, but rather a global assessment may be made of the series of communications involving the athlete's senses, brain and thousands of muscle fibers. The objective of the AR Device is to assess the effectiveness of the interaction of the athlete's visual, cognitive and neuromuscular systems to execute productive movement. Simply stated, the objective is to determine if the athlete is actually fit for game play.

Key measurements include the athlete's reaction time, heart rate and movement speed. The later two measurements can serve as indicators of the athlete's work capacity, which can then be compared to their baseline test(s). Multidirectional reaction time, acceleration, deceleration, velocity and moment-to-moment vertical displacements can also provide valued measurements of the athlete's performance capabilities. The AR Device has the power to detect directional movement asymmetries and deficits that may directly related to actual game play. The athlete's physical work capacity, reaction time to spontaneous cues (prompts) and other key parameters can be compared with baseline tests as well as previous training or assessment sessions.

As discussed above, the AR Device uniquely elevates the athlete's metabolic rate to levels experienced in actual competition for a more sensitive and accurate assessment. Some studies suggest that exercise levels may affect visual acuity. A study by Watanabe (1983) found that exercise at moderate levels (110-120 beats/minute) had no effect on Kinetic Visual Acuity. However, moderate (140-150) and strenuous levels (170-180) demonstrated a significant decrease in KVA.

With the AR Device, the athlete's perceptual (sensing) ability is not tested in isolation, but rather as the initial stage of a continuum of capabilities ranging from the ability to recognize and interpret sport-relevant visual information, to the ability to adeptly execute, and when desired, in a kinematically correct manner. The athlete's visual and cognitive skills are challenged by sensing and responding to sports simulations the demand the athlete pursue the “correct” angle of pursuit while the AR Device measures in real time key performance factors such as reaction time and movement time. With an adjustable (modifable) physical movement area, the assessment environment is uniquely replicate the movement paterns of game play.

Accordingly, the AR Device assessment incorporates aspects of depth perception, dynamic visual acuity, peripheral awareness, anticipation skills, etc.

The AR Device's HMD (“eyewear”) can display virtual objects that are governed by modifiable behaviors that enable scaling of the visual challenges. For example: 1. the rate of transit of the objects, either at a constant velocity or at a speed that varies over the distance traveled, the vector of transit (background to foreground, diagonal, etc.) of the objects, the shape, size, color and number of objects, the pin/rotation of the objects as they travel. The graphical object can be presented in identifiable patterns for pattern recognition drills. Certain visual information can be selectively viewable based on the athlete's instantaneous physical location. The objects can prompt a specific angle of pursuit or interception.

Assessment of Dynamic Visual Acuity and has been shown to be an excellent predictor of recovery from concussion. Unlike static tests, the AR Device uniquely assesses aspects of Dynamic Visual Acuity by causing the athlete's head to be moved in space in a sport-specific manner. “Dynamic Visual Acuity tests assess impairments in an individual's ability to perceive objects accurately while they actively move their head. In normal individuals, losses in visual acuity are minimized during head movements by the vestibular ocular reflex (VOR) system that maintains the direction of gaze on an external target by driving the eyes in the opposite direction of the head movement. When the VOR system is impaired, visual acuity degrades during head movements. Injury to the vestibular system can directly create cognitive deficits, spatial navigation and object recognition memory. The Vestibular System is the remarkably sensitive system which is responsible for the body's sense of motion, and ability to keep balance and to focus the eyes, in response to that sense of motion.” (quoted source)

Balance is the result of several body systems working together: the visual, vestibular and proprioception (Somatosensation); the body's sense of where it is in space. Loss of function in any of these systems can lead to balance deficits. Following a concussion, the ability to coordinate these three systems efficiently may be compromised. The methods and systems described herein can also provide an assessment of the subject's ability to minimize body oscillations in response to visual cues (stimuli). For example, the subject can be provided visual cues prompting head movement while being instructed to minimize body movement resulting from such head movement, with such movement being assessed/tracked by the body/head worn sensors. The subject, for example, can be instructed to stand in a particular stance such as on one leg, one foot in front the other or similar.

One significant advantage of the AR Device is that it enables visual feedback to be delivered to the athlete regardless of the direction in which the athlete is looking (gazing) or the vector direction to which the athlete is moving. The athlete can turn, twist, rotate and abruptly change direction to assume an alternative movement path and still benefit from visual feedback relating to their kinematics and/or physical performance. By eliciting 360 degree movement in addition other benefits, the AR Device acts to challenge the athlete's vestibular system in a profoundly sport-relevant manner in contrast to static balance devices.

The athlete responds to the AR Device's cues with rotations, translations and vertical changes of body position, each vector of movement may act somewhat differently on the vestibular system. The vestibular system contributes to balance and a sense of spatial orientation, essential components of effective athletic movement. It was stated in several papers that visuo-spatial functions represent the brain's highest level of visual processing.

The AR Device's continuous measurement of heart rate provides evidence of the degree to which the athlete is in compliance with the test protocol; heart rate values can be compared to the levels observed during the athlete's prior baseline assessment. Measurement of heart rate can assist in assessment of a concussed subject (or a subject with any of a variety of neurological conditions and/or deficits). For example, a “blunted” or “exaggerated” heart rate response compared with either the subject's baseline test or normative ranges may provide addition information of value in the assessment process. Also material to test validity is the unpredictability of the stimuli delivered to the athlete over multiple tests. The AR Device's randomizing software algorithms ensure that the athlete cannot correctly anticipate subsequent movement challenges.

The versatility of the AR Device affords the clinician, trainer or coach many opportunities to collect baseline data, for example, during the athlete's strength and conditioning and rehabilitation sessions. Baseline averages for each athlete can be calculated from potentially dozens of sessions annually to develop more accurate characterizations of the athlete's baseline global performance. This is in contrast to specialized tests of cognition.

The AR Device's interactive, game-like interface coupled to realtime feedback also acts to improve the athlete's compliance with the testing or training protocol. Motivation is reported frequently as a recognized deficit of sedentary cognitive testing protocols.

The U.S. Patent Application 2011/0270135 A1 provides instruction regarding the construction of the AR Device. The use of a head mounted display (“HMD”) substitutes for the fixed mounted visual display customarily employed with current assessments. The minimal sensor (tracking) configuration requires a sensor affixed in proximity of the athlete's head so that information relating to the head's orientation and position may be reported to the HMD. The information derived from this head-mounted sensor can also be employed to measure qualities related to the athlete's physical performance.

An additional sensor may be affixed in the area of the athlete's body core so that measurements relating to the movement of the athlete's body core can be made. Such measurements may include, but are not limited to, reaction time, acceleration, velocity, deceleration, core elevation and vertical changes and estimated caloric expenditure. Such measurements can be made for each vector direction that the athlete transits; this enables comparison of performance in multi-vectors to detect deficits in the athlete's ability to move with symmetry. If a suitable heart rate sensor is worn by the athlete, heart rate could be reported as well.

An example of AR device use is a simple interactive reaction drill. With this drill, the athlete is presented with unpredictable visual cues that prompt them to move aggressively to follow the desired movement path. The timing and magnitude of the accelerations generated from the HMD tracker can be employed to measure how the athlete responds to the delivered cue. The drill can continue until the desired heartrate is achieved.

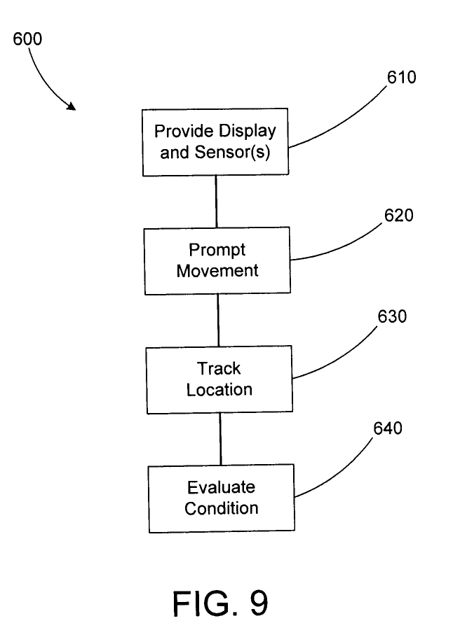

FIG. 9 shows a high-level flow chart of a neurological evaluation method 600 for evaluating a person or subject. In step 610 the person is provided with a wearable display and at least one body movement sensor. The wearable display may be any of the head-mounted displays described above, and the one or more sensors may be any of the extremity and/or body core sensors or controllers.

In step 620 the person is prompted to engage in physical movement, including prompting to engage in physical head movement. The prompts may task-specific cues or prompts, such both planned and unplanned sports-specific cues provided to the subject or user. The cues (prompts) may include virtual reality cues overlaid on real world images. The cues may involve rotations, translations and/or vertical changes of body position, each vector of movement may act somewhat differently on the vestibular system. The visual cues or prompts may prompt the user to move, such as to move along a desired movement path. The cues may be generated using the wearable display, such as an HMD.

During the movement, the view in the wearable display may be updated, based at least in part on movement of the head of the person. For example, the wearable display may be refreshed to reflect the movement of the subject's head, such as being continually refresh to reflect the movement of the subject's head, for example with an overlay (such as a graphic overlay) being refreshed to reflect the movement of the head. The view may be updated based on turning of the head, for example. The view in the viewable display may also provide the ability for a subject, such as an athlete, to view, for example to continuously view, in essentially realtime, visual feedback that relates to the athlete's kinematics (form) during locomotion regardless of the direction in which she is moving or the direction in which he/she is looking, providing tracking means for continuously tracking during movement at least one portion of the athlete's body regardless of the direction in which he/she is moving, presenting to the athlete visual feedback (information) relating to her physical performance derived from said tracking means. Performance information may be presented in engineering units and may include, but is not limited to: reaction time, acceleration, speed, velocity, power, caloric expenditures and/or vertical changes, alternatively, visual feedback (“constructs”) can be presented in the form of game-like scores that may include, but are not limited to: game points earned, tackles, catches, blocks, touchdowns, goals or baskets scored, etc. provided such game-like feedback is directly related to the athlete's physical performance and/or kinematics. Performance constructs employ performance information to discern certain kinematic or biomechanical factors directly relating to the athlete's safety and ability to perform. Performance parameters include, but are not limited to, the quality of the athlete's stance, i.e. the width and depth of stance, the orientation of the knees, etc., and well as the timing and magnitude of the motion of the athlete's kinetic chain. Performance parameters are material to safety and success in both real world game play, as well as in the present invention's virtual world competitions, drills, protocols and games.

In step 630 movement of the person is measured by tracking physical location of the at least one body movement sensor. The measurement may involve determination of any, or any combination of, the constructs described above. The tracking of physical location may involve tracking of absolute physical location, or may involve tracking changes in physical location. The tracking of physical location may involve tracking physical location of the body of the person as a whole (the body core), or may involve tracking of a part of the body, such as an extremity or head of the body. The tracking of physical location may involve tracking translations/positions of the body or part of the body, or may involve tracking orientation and/or posture changes. The term “physical location” should therefore be construed broadly as relative or absolute locations, including changes in orientation.

Finally, in step 640 the neurological condition of the person is evaluated based at least in part on measured movement of the at least one body movement sensor. The evaluation may involve use of any, or any combination of, the constructs described above. The evaluating data may include comparing the data obtained in the tracking movement with data from a baseline evaluation, may involve comparing the data obtained in the tracking movement with previously-collected data, may involve the previously-collected data including data from a baseline evaluation, may involve the previously-collected data includes data from tracking movement of other persons, may involve the comparing data including determining whether the person has a cognitive impairment, may involve the comparing data including determining whether the person is suffering from concussion symptoms, and/or may involve the comparing data including determining whether the person is suffering from neurological disease symptoms, to give just a few examples. For instance, a significant change from a baseline result, for example a change of reaction time (or another construct) by more than a predetermined amount, may be an indicator of neurological impairment (under certain conditions, for instance when the subject's metabolic rate is elevated).

For example, resting heart rate for a healthy young athlete may be 45-70 beats per minute (bpm. During a sport and/or task the heart rate may raise considerably, for example a basketball player on a fast break may achieve a heart rate in excess of 150 to 180 bpm. When testing post concussion to compare to a baseline (or normative data), it is beneficial for the athlete to reach a heart rate commensurate to levels achieved in actual competition. Combining a system for prompting movement, with feedback concerning heart rate, allows this to be accomplished. Measurement of heart rate and movement speed may be used as indicators of the athlete's capacity for work. For example, assume an athlete's baseline test measured a maximum velocity of 6.2 ft/sec, maximum heart rate of 185 bpm, and average reaction time of 0.7 sec. If the athlete post concussion achieves these baseline levels without symptoms, it may be assumed that he or she is now “fit to play.” This is just one example of many possible ways the evaluation can be carried out.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method of neurological evaluation a person, the method comprising:
providing the person with a wearable display and at least one body movement sensor;
prompting physical movement of the person, including prompting physical movement of a head of the person;
during the prompting physical movement, updating a view in the wearable display, based on movement of the head of the person;
measuring movement of the person by tracking physical location of the at least one body movement sensor; and
evaluating a neurological condition of the person, based at least in part on measured movement of the at least one body movement sensor.

2. The method of claim 1,
wherein the providing with the wearable display includes providing the person with a optically-see-through head-mounted display; and
wherein the updating the view includes updating a view that is overlays virtual content on a view through the display.

3. The method of claim 1,
wherein the at least one sensor includes a sensor on a lower extremity of the person; and
wherein the evaluating includes evaluating based at least in part on measured movement of the lower extremity from tracking the sensor on the lower extremity.

4. The method of claim 1,
wherein the at least one sensor includes sensors on both lower extremities of the person; and
wherein the evaluating includes evaluating based at least in part on measured movement of the lower extremities from tracking the sensors on the lower extremities.

5. The method of claim 1,
wherein the at least one sensor includes a body core sensor that tracks movement of a body core of the person; and
wherein the evaluating includes evaluating based at least in part on measured movement of the body core from tracking the body core sensor.

6. The method of claim 1, wherein the prompting includes prompting turning of the head of the person.

7. The method of claim 1, wherein the prompting includes prompting the person to change body core vertical position.

8. The method of claim 1, wherein the prompting includes prompting the person to engage in forward-and-back movements, side-to-side movements, and turning movements.

9. The method of claim 1, wherein the prompting includes prompting sudden changes in movement of the person.

10. The method of claim 1, wherein the prompting includes task-specific prompting to engage in physical movement at least partially simulating a real-world task engaged in by the person.

11. The method of claim 10, wherein the task-specific prompting includes sports-specific prompting of the person to engage in physical movement that at least partially simulates a sports task.

12. The method of claim 11, wherein the sports-specific prompting includes prompting of sports-specific head movement.

13. The method of claim 10, wherein the prompting includes prompting movement sufficient to elevate the person's metabolic rate to a level consistent with the real-world task.

14. The method of claim 13,
further comprising monitoring heart rate of the person using a heart rate sensor; and
wherein the prompting includes using the monitoring to control the prompting, to achieve a heart rate consistent with real-world task.

15. The method of claim 10, wherein the task-specific prompting includes prompting to engage in physical movement similar to that of a task in which the person suffered a possible neurological injury.

16. The method of claim 10, wherein the evaluating includes assessing neurological suitability of the person engaging in the real-world task.

17. The method of claim 1, wherein the updating of the view includes a substantially continuous updating of the view.

18. The method of claim 1, wherein the evaluating includes comparing with baseline results.

19. The method of claim 1, wherein the evaluating includes evaluating based at least in part on reaction time determined from the measuring movement.

20. The method of claim 1, wherein the evaluating includes evaluating based at least in part on acceleration determined from the measuring movement.
